(19) United States
(12) Patent Application Publication
(10) Pub. No.: US 2022/0411447 A1
(43) Pub. Date: Dec. 29, 2022

(54) Methods of Preparing Primary Phosphine Products Using Lewis Acid Catalysts

(71) Applicant: The University of Vermont and State Agricultural College, Burlington, VT (US)

(72) Inventors: Rory Waterman, Burlington, VT (US); Brandon Ackley, Beavercreek, OH (US)

(21) Appl. No.: 17/787,650

(22) PCT Filed: Jan. 7, 2021
(86) PCT No.: PCT/US21/12466

§ 371 Date: Jun. 21, 2022

Related U.S. Application Data
(60) Provisional application No. 62/960,773, filed on Jan. 14, 2020.

(51) Int. Cl. C07F 9/50

(52) U.S. Cl. CPC C07F 9/5072

(57) ABSTRACT

Methods of preparing primary phosphine products using one or more precursor cyclophosphanes, hydrogen, and one or more Lewis acid catalysts. In some embodiments, a cyclophosphane precursor and at least one Lewis acid are dissolved in a solvent to provide a solution. The solution is treated with hydrogen, and optionally heated, to cause a reaction that produces a primary phosphine © product. The primary phosphine product may be isolated from the Lewis acid(s) and optionally purified. In some embodiments, a method may include synthesizing the cyclophosphane precursor prior to mixing the cyclophosphane precursor and the Lewis acid(s).

### PRIOR APPLICATION DATA

The present application claims the benefit of priority of U.S. Provisional Patent Application Ser. No. 62/960,773, filed on Jan. 14, 2020, and titled “METHODS OF PREPARING PRIMARY PHOSPHINES USING A LEWIS ACID CATALYST”, which is incorporated by reference herein in its entirety.

### STATEMENT REGARDING FEDERALLY SPONSORED RESEARCH OR DEVELOPMENT

This invention was made with government support under grant CHE-1565658 awarded by the National Science Foundation. The government has certain rights in the invention.

### FIELD OF THE DISCLOSURE

The present disclosure generally relates to the field of chemical synthesis of primary phosphines. In particular, the present disclosure is directed to methods of preparing primary phosphine products using Lewis acid catalysts.

### BACKGROUND

Primary phosphines have the general structure R-P-H₂. Primary phosphines are currently commercial reagents and, as a class, are useful intermediates in various industrial processes such as subsequent chemical synthesis processes, pharmaceutical manufacture, materials science, and semiconductor fabrication. Conventional methods for preparing primary phosphines require the use of highly hazardous reagents. One conventional method is alkylation of white phosphorus, a pyrophoric solid. Another conventional method involves substitution of organic precursors into phosphine (PH₃), a highly toxic gas. These conventional methods typically have low yields and generate substantial quantities of hazardous wastes.

### SUMMARY OF THE DISCLOSURE

In one implementation, the present disclosure is directed to a method of preparing a primary phosphine product, which includes providing a precursor comprising a cyclophosphane with the general formula (R-P)n, where R is any organic functional group; mixing a Lewis acid with the precursor to provide a mixture; treating the mixture of the precursor and the Lewis acid with hydrogen under reaction conditions suitable for forming the primary phosphine product from the mixture; and separating the Lewis acid from the primary phosphine product so as to isolate the primary phosphine product.

In another implementation, the present disclosure is directed to a method of preparing a primary phosphine product, which includes providing a precursor comprising a cyclophosphane with the general formula (R-P)n, where R is any organic functional group; mixing a Lewis acid with the precursor and a solvent to provide a solution; treating the solution of the precursor and the Lewis acid with hydrogen; heating the hydrogen and the mixture of the precursor and the Lewis acid; and removing the Lewis acid and the solvent so as to isolate the primary phosphine product.

In yet another implementation, the present disclosure is directed to a method of preparing a primary phosphine product, which includes providing a precursor with the general formula R-P-X2, where R is an organic functional group and X is a halogen; reacting the precursor with a dehalogenating agent so as to remove both halogens X and form a cyclophosphane of the general formula (R-P)n; mixing a Lewis acid with the cyclophosphane to create a mixture; contacting the mixture of the cyclophosphane and the Lewis acid with hydrogen gas; heating the hydrogen gas and the mixture of the cyclophosphane and the Lewis acid; and removing the Lewis acid to isolate the primary phosphine product.

### DETAILED DESCRIPTION

Some aspects of the present disclosure are directed to methods of preparing any of a variety of primary phosphines using hydrogen gas and a Lewis acid. A method of the present disclosure may be performed in two phases: preparation of a cyclophosphane followed by conversion of the cyclophosphane to a primary phosphine. Alternatively, if a cyclophosphane is already in hand, a method of the present disclosure may include only the conversion process.

As used herein and in the appended claims, the term “anhydrous” refers to having about 1% by weight of water or less, typically about 0.5% by weight of water or less, often about 0.1% by weight of water or less, more often about 0.01% by weight of water or less, and most often about 0.001% by weight of water or less. Within this definition, the term “substantially anhydrous” refers to having about 0.1% by weight of water or less, typically about 0.01% by weight of water or less, and often about 0.001% by weight of water or less.

Throughout the present disclosure, the term “about” when used with a corresponding numeric value or an amount (e.g., a “minimum” amount) refers to ±20% of the numeric value or amount, typically ±10% of the numeric value or amount, often±5% of the numeric value or amount, and most often±2% of the numeric value or amount. In some embodiments, the term “about” can mean the numeric value or amount itself.

When describing a chemical reaction, such as any of the synthesis reactions described herein and/or addressed in the appended claims, the terms “mixing”, “treating”, “contacting”, and “reacting”, are used interchangeably and refer to adding or mixing two or more reagents under the conditions sufficient to produce the indicated and/or desired product(s). It should be appreciated that the reaction that produces the indicated and/or desired product may not necessarily result directly from the combination of the reagent(s) that was/were initially added. That is, there may be one or more intermediates that are produced in the mixture and ultimately lead to the formation of the indicated and/or desired product.

As described in this disclosure, primary phosphines can be synthesized by a route that avoids the use of pyrophoric reagents, instead relying on hydrogen gas and a Lewis acid catalyst. This solves the industrial concern of using large quantities of pyrophoric reagents and avoids the stochiometric amount of hazardous waste that is generated in conventional methods. Additionally, the disclosed methods are general. Any primary phosphine can be prepared by this method depending on the substituent on phosphorus in the precursor. As a more general route than those routes conventionally known, a manufacturer may prepare many different derivatives and respond better to customer needs. Given that current technologies are both hazardous and many are low-yielding, costs for the end products would typically decrease using the disclosed method(s) relative to similar products made using a conventional method. The primary phosphine may be prepared by the disclosed method at another location and provided to an end user, or prepared in situ at the point of intended use.

As mentioned above, in some embodiments a method of the present disclosure may include first preparing a cyclophosphane precursor. A cyclophosphane precursor may include any one or more types of cyclophosphane, depending on the desired composition of the primary phosphine end product.

In some embodiments, preparation of the precursor cyclophosphane(s) may be performed using known methods, for example, as described by Baudler, M. and Glinka, K., “Organocyclophosphanes” in Inorganic Synthesis, Allcock, H. R., Ed. 1989; Vol. 25. This method specifies reacting a parent phosphine dihalogen with a dehalogenating agent to form cyclophosphanes. Although phosphine dichlorides are commonly used in this preparation, precursors containing other halogens may be employed. The dehalogenating agent is typically a metal powder, such as a zinc or magnesium powder, although other agents may also be employed. Although in the examples given below cyclophosphanes were prepared with methods similar to those described in the aforementioned Baudler and Glinka publication, various other methods of preparing cyclophosphanes could be used in various embodiments of the disclosed method. Those skilled in the art will readily understand where to find resources describing those methods, as well as the methods themselves, such that a detailed explanation of such methods herein is not required for those skilled in the art to practice the methods of this disclosure to their fullest scope.

Following preparation of the precursor cyclophosphane that includes the desired functional group, the cyclophosphane precursor is converted to the desired primary phosphine by reacting the cyclophosphane(s) of the cyclophosphane precursor with hydrogen gas in the presence of a Lewis acid catalyst. As noted above, when a cyclophosphane precursor is already in hand, the preparation of the precursor cyclophosphane(s) can be skipped. In this case, a method of the present disclosure may start with providing a cyclophosphane precursor and then proceed with converting that cyclophosphane precursor to the desired primary phosphine by reacting the cyclophosphane(s) of the cyclophosphane precursor with hydrogen gas in the presence of a Lewis acid catalyst.

Typically and at a high level, the converting of a cyclophosphane precursor to a desired primary phosphine product proceeds as follows. Once the cyclophosphane precursor is prepared or otherwise provided, the cyclophosphane(s) of the cyclophosphane precursor and one or more Lewis acid catalysts (typically, only one), are dissolved in a suitable solvent and mixed with the solvent to provide a solution. Mixing may be performed in any suitable manner. Higher concentrations favor rapid product formation, so lowest volumes of solvent are preferred. Mass transfer of hydrogen through solvents can be poor given generally low solubility of H₂, which can be another reason to keep total solvent volume low. In some instantiations, the optimal amount of solvent(s) is the minimum amount of solvent needed to just fully dissolve the reagents at ambient temperature surrounding the solution. As used herein and in the appended claims, “just fully dissolve” means that the concentration of the reagents in the solution is substantially a maximum by virtue of the amount of solvent being the amount where the solution just crosses the line between the solution containing undissolved reagent and the solution containing no undissolved reagent in a direction toward the solvent containing no undissolved reagent. Those skilled in the art will readily appreciate that, in practice, the minimum amount will be qualified by the term “about” due to inexact nature of preparing a solution and determining precisely when the solution crosses the line between a small amount of undissolved reagent and no undissolved reagent. In some instantiations, the solvent can be eliminated and the cyclophospane precursor mixed directly with the Lewis acid(s) to form a mixture. However, experiments performing the conversion method without a solvent have resulted in relatively low yields and/or an excessive byproducts. It is noted that the cyclophosphanes are typically solids at typical reaction temperatures, and catalysts are commonly solids with some liquids or solutions.

The solution or mixture is treated with hydrogen (typically as H₂ gas), and heat may be applied at least while the solution or mixture is being treated with the hydrogen and while the conversion reaction proceeds to produce the desired primary phosphine product. In some instantiations, the solution or mixture may be present in a vacuum-type reaction chamber. In such instantiations, the hydrogen treatment may be performed by evacuating the reaction chamber and flowing H₂ gas into the reaction chamber. Optionally, the solution or mixture may be frozen prior to treatment with the hydrogen. Freezing of the mixture may be accomplished, for example, using liquid nitrogen.

At an appropriate time, the desired primary phosphine product is separated from the Lewis acid catalyst(s), typically as quickly as practicable, to isolate the primary phosphine product. In some instantiations, the appropriate time for separation may be determined based on, for example, model reactions or after monitoring the relevant reaction by ³¹P NMR spectroscopy to show conversion to the desired primary phosphine product. The primary phosphine product is typically a liquid or gas and can be separated from the reaction mixture by distillation. The isolated primary phosphine product may then be purified using any suitable purification technique, including purification techniques known to purify primary phosphine products made by other methods. In some embodiments, distillation is a useful purification technique for purifying the primary phosphine product.

Solvents suitable for use in the disclosed method include, but are not limited to, dichloromethane (CH₂Cl₂) (DCM), diethyl ether ((C₂H₅)₂O) (DEE), tetrahydrofuran (C₄H₈O) (THF), toluene (C₇H₈), and other anhydrous, oxygen-free, aprotic polar organic solvents. Generally, solvents having high hydrogen gas solubility and that do not coordinate strongly with the Lewis acid catalyst result in the best reaction rates and yields. Generally, the solution created using a solvent should be free of molecular oxygen (O₂), which those skilled in the art will understand would be detrimental to preparing primary phosphines. As used herein and in the appended claims, the term “solvent” can be construed as either a single suitable solvent or, in the alternative, a mixture of two or more suitable solvents, as appropriate under the circumstances.

Lewis acids suitable for use in the disclosed method include, but are not limited to, tris(pentafluorophenyl)borane (C₁₈F₁₅B) (BCF), boron trifluoride (BF₃), and borane (BH₃). The Lewis acid chosen must be sufficiently soluble in the selected solvent so as to achieve the desired reaction rate. The strength of the Lewis acid relative to the reagents positively affects the reaction rate, and therefore some Lewis acids such as zinc chloride (ZnCl₂) were found to result in slow reactions and/or low yields. Other examples of suitable Lewis acids include very low pKₐ acids (e.g., acids having a pKₐ of about 1 or less), like triflic acid (HO₃SCF₃). However, it is noted that these are generally like ZnCl₂ in that they typically result in limited yields or are otherwise slow.

The reaction with hydrogen gas may be performed at a pressure in a range of pressures and at a temperature in a range of temperatures. Higher partial pressures of hydrogen tend to increase the reaction rate and increase the yield by forcing the equilibrium towards the primary phosphine product. As the rate is typically limited by the amount of hydrogen dissolved in the solvent, higher temperatures may or may not increase the reaction rate, depending on the solubility curve for hydrogen in the solvent. Acceptable yields (as high as quantitative), can typically be obtained within about 4 hours to about 24 hours, for example, with a hydrogen partial pressure of about 2 atmospheres (202,650 kPa) and temperatures in the range of about 65° C. to about 110° C. However, other reaction conditions may also produce acceptable yields. In some instantiations, isolated yields range from about 80% to 100%, with purity typically >95%, as measured by NMR spectroscopy.

Non-limiting embodiments illustrating aspects of the present disclosure are described below in the context of several specific examples. It should be understood that the present invention is not limited to the examples given below. Rather, they are merely examples that illustrate the general principles applied to specific chemicals so that those skilled in the art can appreciate the general principles. Those skilled in the art, using this present disclosure as a guide as to the general principles, will be able to use these examples to implement the general principles to other combinations of precursor cyclophosphanes, solvents, and Lewis acids that similarly produce corresponding desired primary phosphines.

The processes of all non-general examples below were performed under an inert atmosphere of N₂ using Schlenck line or glovebox techniques. NMR spectra were recorded using a Bruker AXR 500 MHz spectrometer and were referenced to residual solvent impurities for ¹H NMR spectra and an external reference of 85% H₃PO₄ in H₂O for ³¹P NMR spectra. All reagents were obtained from commercial suppliers and dried by conventional means as necessary. It should be understood that embodiments need not use the same apparatus or methods of analyzing the resulting product. Differing apparatuses and analysis methods as known in the art may be used without departing from the spirit and scope of the disclosed methods. Although the examples given below reflect laboratory conditions and quantities, it should be understood that the disclosed method may be scaled to produce commercial quantities without departing from the spirit and scope of the disclosed method.

### Example General Synthesis of Cyclophosphanes ((P-R)ₙ)

A 50 mL flask was charged with the parent phosphine dichloride (8.8 mmol R-P-C₁₂) and THF (10 mL), and the solution was vigorously stirred at room temperature. While stirring, zinc powder (8.8 mmol) was added as a dehalogenating agent over approximately one minute. The resulting mixture was stirred for 16 hours, after which volatile materials were removed under reduced pressure. Toluene was added to extract the cyclophosphanes from the remaining mixture, followed by filtering of the toluene solution through a medium porosity fit partially filled (approximately 1/3) with Celite® .diatamcous earth filter aid. Volatile materials, including the toluene solvent, were removed under reduced pressure. The remaining material comprised the cyclophosphanes (P-R)ₙ with a high yield, as high as quantitative.

The cyclophosphane product is a mixture of compounds with different phosphorus ring sizes. A typical ring size is five phosphorous atoms, (P-R)₅. However, there is typically no requirement to separate the mixture, as subsequent steps of the disclosed method successfully convert compounds with a range of cyclophosphane ring sizes into the desired primary phosphine.

### Example General Synthesis of Primary Phosphines (R-P-H₂)

A 50 mL pressure vessel was charged with a cyclophosphane (0.5 mmol), BCF (0.025 mmol), and 10 mL of a solvent such as THF or toluene. The solution was frozen using liquid nitrogen, and the vessel evacuated. The vessel was then charged with H₂ gas to final pressure of approximately 2 atmospheres. The solution was then heated to between 65° C. and 110° C. for 4 to 24 hours, resulting in formation of the desired phosphine. The product was then stabilized by removing the Lewis acid, which otherwise would catalyze the reverse reaction. Yields of the primary phosphine as high as 99% versus the cyclophosphane charge have been observed by the present inventors.

The general method is suitable for production of a wide range of primary phosphines. Variations of this method were performed by the present inventors to produce, for example, phenylphosphine, methylphosphine, tert-butyl phosphine, and para-tolylphosphine, among others. The pressure of H₂ gas may be varied from 2 atmospheres as described in the example embodiments. In general, higher pressure obtains a faster reaction rate. The temperature may likewise be varied from the 65° C. and 110° C. range in the example embodiments, and is preferably set at or near the boiling point of the solvent utilized. In a similar manner, the reaction times may be varied as needed to obtain a desired yield or limit the production of byproducts. Those skilled in the art will readily appreciate from reading this disclosure how to perform the basic methodologies disclosed herein under a wide variety of reaction conditions. In addition, those skilled in the art will be able to ascertain the reaction conditions suitable for their purposes without undue experimentation using routine optimization techniques known in the art.

A proportion of the Lewis acid catalyst to cyclophosphane of approximately 1 mol % with respect to the R-P content of the cyclophosphane has been demonstrated by the inventors to be suitable, although other proportions may be used in various embodiments without departing from the spirit and scope of the disclosed method.

### Example Synthesis of Phenylphosphine (PhPH2)

A 50 mL pressure vessel was charged with cyclophenylphosphane (0.5 mmol), BCF (0.025 mmol), and 10 mL of a solvent such as toluene. The solution was frozen using liquid nitrogen, and the vessel evacuated. The vessel was then charged with H₂ gas to final pressure of approximately 2 atmospheres. The solution was then heated to approximately 110° C. for approximately 4 hours, resulting in formation of phenylphosphine.

Production of phenylphosphine was verified by comparison of NMR spectra with commercial samples and literature reports. It was observed that attempting to run the reaction without a solvent resulted in comparatively poor yields with large amounts of unwanted byproducts.

### Example Synthesis of Methyl Phosphine (MePH2)

A 50 mL pressure vessel was charged with cyclomethylphosphane (0.5 mmol), BCF (0.025 mmol), and 10 mL of a solvent such as THF. The vessel was then charged with H₂ gas to final pressure of approximately 2 atmospheres. The solution was then heated to approximately 65° C. for approximately 8 hours, resulting in formation of methylphosphine.

As methylphosphine is a gas, determination of yield can be determined through the loss of mass of residual starting material. Conversion of cyclomethylphosphane was observed routinely higher than 90%, with some examples as high as >99%. Production of methylphosphine was verified by reacting the product obtained above with diphenyl disulfide (PhS)₂ to produce an expected product of PhS(PMe)SPh. A ³¹P NMR spectrum of this product showed successful conversion to methylphosphine.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above. It will be understood by those skilled in the art that various changes, omissions and additions may be made to that which is specifically disclosed herein without departing from the spirit and scope of the present disclosure.

What is claimed is:

1. A method of preparing a primary phosphine product, comprising:
providing a precursor comprising a cyclophosphane with the general formula (R-P)ₙ, where R is any organic functional group;
mixing a Lewis acid with the precursor to provide a mixture;
treating the mixture of the precursor and the Lewis acid with hydrogen under reaction conditions suitable for forming the primary phosphine product from the mixture; and
separating the Lewis acid from the primary phosphine product so as to isolate the primary phosphine product.

2. The method of claim 1, wherein the Lewis acid is selected from the group consisting of tris(pentafluorophenyl)borane (C₁₈F₁₅B) (BCF), boron trifluoride (BF₃), and borane (BH₃).

3. The method of claim 1, wherein the Lewis acid has a pKₐ of about 1 or less.

4. The method of claim 1, wherein mixing a Lewis acid with the precursor includes mixing the Lewis acid and the precursor with a solvent to provide a solution.

5. The method of claim 4, wherein the solvent comprises at least one anhydrous, oxygen-free, aprotic polar solvent.

6. The method of claim 5, wherein the at least one anhydrous, oxygen-free, aprotic polar solvent is selected from the group consisting of dichloromethane (CH₂Cl₂) (DCM), diethyl ether ((C₂H₅)₂O) (DEE), tetrahydrofuran (C₄H₈O) (THF), toluene (C₇H₈).

7. The method of claim 4, wherein the mixing the Lewis acid and the precursor with a solvent includes mixing the Lewis acid and the precursor with about a minimum amount of the solvent needed to just fully dissolve the Lewis acid and the precursor.

8. The method of claim 4, further comprising removing the solvent and the Lewis acid so as to isolate the primary phosphine product.

9. The method of claim 1, further comprising purifying the primary phosphine product to a purity of greater than about 95%.

10. The method of claim 1, wherein treating the mixture with hydrogen includes contacting the mixture with H₂ gas.

11. The method of claim 1, wherein the reaction conditions include heating the mixture to a temperature in a range of about 65° C. to about 110° C.

12. The method of claim 11, wherein the reaction conditions include providing a hydrogen partial pressure of about 2 atmospheres.

13. The method of claim 11, wherein the reaction conditions include treating the mixture with hydrogen for a period of about 4 hours to about 24 hours.

14. The method of claim 1, wherein the reaction conditions include reaction conditions suitable to provide a yield of the primary phosphine product of at least about 80%.

15. The method of claim 14, wherein the reaction conditions include reaction conditions suitable to provide a yield of about 100%.

16. The method of claim 1, wherein the providing of the precursor includes synthesizing the precursor.

17. A method of preparing a primary phosphine product, comprising:
providing a precursor comprising a cyclophosphane with the general formula (R-P)ₐ, where R is any organic functional group;
mixing a Lewis acid with the precursor and a solvent to provide a solution;
treating the solution of the precursor and the Lewis acid with hydrogen;
heating the hydrogen and the mixture of the precursor and the Lewis acid; and
removing the Lewis acid and the solvent so as to isolate the primary phosphine product.

18. The method of claim 17, wherein the Lewis acid is selected from the group consisting of tris(pentafluorophenyl)borane (C₁₈F₁₅B) (BCF), boron trifluoride (BF₃), and borane (BH₃).

19. The method of claim 17, wherein the Lewis acid has a pKₐ of about 1 or less.

20. The method of claim 17, wherein the solvent comprises at least one anhydrous, oxygen-free, aprotic polar solvent.

21. The method of claim 20, wherein the at least one anhydrous, oxygen-free, aprotic polar solvent is selected from the group consisting of dichloromethane (CH₂Cl₂) (DCM), diethyl ether ((C₂H₅)₂O) (DEE), tetrahydrofuran (C₄H₈O) (THF), toluene (C₇H₈).

22. The method of claim 17, wherein the mixing the Lewis acid with the precursor and the solvent includes mixing the Lewis acid and the precursor with about a minimum amount of the solvent needed to just fully dissolve the Lewis acid and the precursor.

23. The method of claim 17, further comprising purifying the primary phosphine product to a purity of greater than about 95%.

24. The method of claim 17, wherein treating the mixture with hydrogen includes contacting the mixture with H₂ gas.

25. The method of claim 17, wherein the reaction conditions include heating the mixture to a temperature in a range of about 65° C. to about 110° C.

26. The method of claim 25, wherein the reaction conditions include providing a hydrogen partial pressure of about 2 atmospheres.

27. The method of claim 25, wherein the reaction conditions include treating the mixture with hydrogen for a period of about 4 hours to about 24 hours.

28. The method of claim 17, wherein the reaction conditions include reaction conditions suitable to provide a yield of the primary phosphine product of at least about 80%.

29. The method of claim 28, wherein the reaction conditions include reaction conditions suitable to provide a yield of about 100%.

30. The method of claim 17, wherein the providing of the precursor include synthesizing the precursor.

31. A method of preparing a primary phosphine product, comprising:
providing a precursor with the general formula R-P-X2, where R is an organic functional group and X is a halogen;
reacting the precursor with a dehalogenating agent so as to remove both halogens X and form a cyclophosphane of the general formula (R-P)ₙ;
mixing a Lewis acid with the cyclophosphane to create a mixture;
contacting the mixture of the cyclophosphane and the Lewis acid with hydrogen gas;
heating the hydrogen gas and the mixture of the cyclophosphane and the Lewis acid; and
removing the Lewis acid to isolate the primary phosphine product.

32. The method of claim 31, wherein both halogens are chlorine (Cl).

33. The method of claim 31, wherein the dehalogenating agent includes one or more of Zn or Mg.

34. The method of claim 31, wherein the Lewis acid is selected from the group consisting of tris(pentafluorophenyl)borane (C₁₈F₁₅B) (BCF), boron trifluoride (BF₃), and borane (BH₃).

35. The method of claim 31, wherein the Lewis acid has a pKₐ of about 1 or less.

36. The method of claim 31, wherein mixing a Lewis acid with the precursor includes mixing the Lewis acid and the precursor with a solvent to provide a solution.

37. The method of claim 36, wherein the solvent comprises at least one anhydrous, oxygen-free, aprotic polar solvent.

38. The method of claim 37, wherein the at least one anhydrous, oxygen-free, aprotic polar solvent is selected from the group consisting of dichloromethane (CH₂Cl₂) (DCM), diethyl ether ((C₂H₅)₂O) (DEE), tetrahydrofuran (C₄H₈O) (THF), toluene (C₇H₈).

39. The method of claim 36, wherein the mixing the Lewis acid and the precursor with a solvent includes mixing the Lewis acid and the precursor with about a minimum amount of the solvent needed to just fully dissolve the Lewis acid and the precursor.

40. The method of claim 36, further comprising removing the solvent and the Lewis acid so as to isolate the primary phosphine product.

41. The method of claim 31, further comprising purifying the primary phosphine product to a purity of greater than about 95%.

42. The method of claim 31, wherein treating the mixture with hydrogen includes contacting the mixture with H₂ gas.

43. The method of claim 31, wherein the reaction conditions include heating the mixture to a temperature in a range of about 65° C. to about 110° C.

44. The method of claim 43, wherein the reaction conditions include providing a hydrogen partial pressure of about 2 atmospheres.

45. The method of claim 43, wherein the reaction conditions include treating the mixture with hydrogen for a period of about 4 hours to about 24 hours.

46. The method of claim 31, wherein the reaction conditions include reaction conditions suitable to provide a yield of the primary phosphine product of at least about 80%.

47. The method of claim 46, wherein the reaction conditions include reaction conditions suitable to provide a yield of about 100%.

48. The method of claim 31, wherein the providing of the precursor includes synthesizing the precursor.
